(19) United States
(12) Patent Application Publication
(10) Pub. No.: US 2004/0182950 A1
(43) Pub. Date: Sep. 23, 2004

(54) Integrated automated spraying machine for livestock

(76) Inventor: Real Duranceau, St-Lambert (CA)

Correspondence Address: INVENTARIUM, # 1607, 4050 Rosemont blvd, Montreal, QC, H1X 1M4, CA

(21) Appl. No.: 10/389,211

(22) Filed: Mar. 17, 2003

(51) Int. Cl. B67D 5/08

(52) U.S. Cl. 239/71

(57) ABSTRACT

A spraying machine comprised of a suspended frame shaped like an inverted <<U>> which is lowered to an appropriate height, according to the stock to be sprayed. On each leg of the inverted U is at least one spray nozzle. To trigger the nozzle, at least one motion detector detects the presence of an animal passing through the inverted <<U>> and a pump creates the necessary pressure to propel a liquid taken from a tank.

### BACKGROUND OF THE INVENTION

1. Field of the Invention

This invention relates generally to spraying machines but more particularly to a machine that sprays products, such as insect repellent onto animals, more specifically livestock.

2. Background

Although the prior art is replete with various spraying machines, none appear to be directed at spraying for livestock and none appear to show any permanent or near permanent integrated installations suitable for such an activity.

Because flies and other such insects are always very much present inside a barn or any such farm building, it is necessary for a farmer to regularly spray insect repellent on his livestock. Besides being a great source of bother and discomfort to humans, insects can also be stressful to the livestock which can actually affect milk output in dairy cows.

Because of environmental issues, it is also important that not too much insect repellent be applied so a way to spray just the right amount of insect repellent has to be found.

There are many anecdotal instances of farmers jerry rigging spraying machines inside doorway frames where they trigger a release of insect repellent on a passing animal but such systems are manually operated and are not really timesaving for the farmer.

For these reasons, there is a need for a practical, economical and simple way of spraying livestock

### SUMMARY OF THE INVENTION

It is a first object of this invention to provide for an integrated automated livestock spraying machine.

It is a second object of this invention to be practical and easy to operate.

It is a third object of this invention to be stowable when not in use so as not to be an encumberance.

It is a fourth object of this invention to be loosely attached so that it can absorb hits.

It is a final object of this invention to minimize waste by directing the sprays in a very delimited area and for a predetermined amount of time or quantity.

In order to do so, the present invention is comprised of a suspended frame shaped like an inverted <<U>> which is lowered to an appropriate height, according to the stock to be sprayed. On each leg of the inverted <<U>> is at least one spray nozzle. To trigger the nozzle, at least one motion detector detects the presence of an animal passing through the inverted <<U>> and a pump creates the necessary pressure to propel a liquid taken from a tank.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

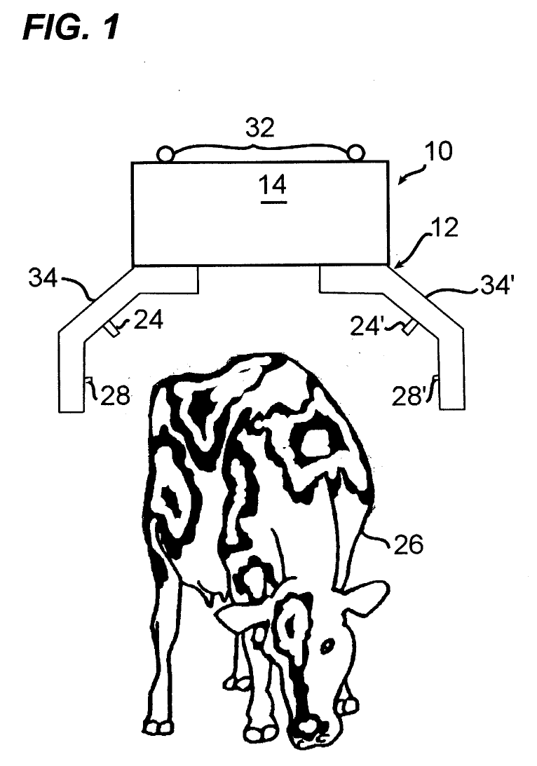

FIG. 1 Front view of the machine in use.

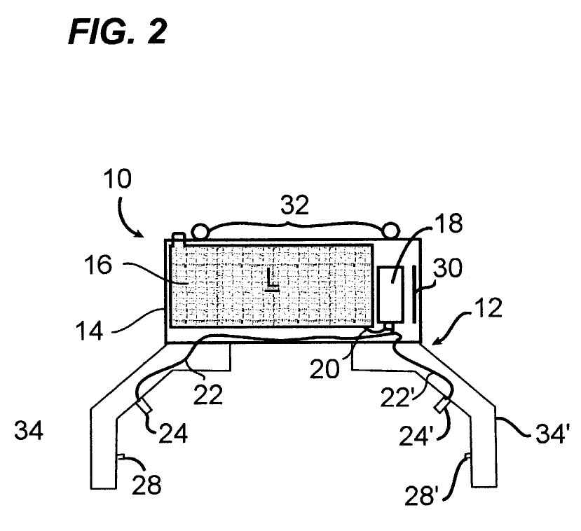

FIG. 2 Front elevation of the interior of the casing.

### DETAILED DESCRIPTION OF THE PREFERRED EMBODIMENT

An integrated automated spraying machine for livestock (10) has a suspended frame (12) shaped like an inverted U. Within that frame is a containment box (14) and a pair of legs (34, 34′). The containment box (14) contains a tank (16) a pump (18) and pipes which are comprised of a short tank pipe (20) which takes a liquid “L” from the tank (16) to the input of the pump (18) from there, a second set of pipes (22, 22′) takes the vaporizing liquid “L” from the output of the pump (18), down into the legs (34, 34′) of the frame (12) to a pair of nozzles (24, 24′). For the purpose of illustration, only two nozzles (24, 24′) are shown but more could be installed.

In order to trigger the spraying machine (10) an animal (26) has to trigger the motion detectors (28, 28′) (although only one could be needed). Since an animal (26) can stay in place for longer than necessary, a control box (30) handles all matters of electrical and electronic activities which includes a timer so that a preset time duration will stop the spraying. Since the flowrate is known, a certain volume of vaporizing liquid “L” is released in a given amount of time.

Hooks (32) that are mechanically fastened to the top of the containment box (14) are used to hang the integrated automated spraying machine for livestock (10) from an overhead structure by using chains, cables or any combinations thereof. An advantage of suspending the spraying machine (10) is that if it is hooked to a hoist, the spraying machine (10) can be raised up and out of the way when not in use and does not encumber floor space. Also, the fact that it is loosely attached, if an animal (26) would become restless, the spraying machine (10) would be able to take the hits with little or no damage to the machine (10) or injury to the animal (26) since it it not rigidly held in place.

In order to use the machine (10), if not already in place, it is first lowered at the appropriate height and the liquid <<L>> is poured into the tank (16). A master switch is set to ON in order to set the timer from the control box (30) to regulate the duration of the spray based on recommendation from the manufacturer of the liquid <<L>> being used. A second switch in the control box (30) actuates the motion detector (24, 24′) and sets it to automatic. Still part of the control box (30), an optional manual override can control the stops and starts of the spray.

1. An integrated automated spraying machine for livestock comprising:
a suspended frame shaped like an inverted <<U>>;
said frame further comprising a containment box and a pair of legs in combination to give the inverted <<U>> shape;
the containment box containing within it a tank, a pump, a control box and pipes;
pipes to carry the liquid to;
at least one nozzle and said nozzle used to spray a vaporizing liquid;
at least one motion detector to detect the presence of an animal between the pair of legs;
the control box to control the release and duration of the spray from the nozzle.

2. An integrated automated spraying machine for livestock as in claim 1 further comprising:
a set of pipes comprised of a short tank pipe to take the vaporizing liquid from the tank to the input of the pump;
a second set of pipes to take the liquid from the output of the pump down into the legs and onto a pair of nozzles.

3. An integrated automated spraying machine for livestock as in claim 1 further comprising:
Hooks that are mechanically fastened to the top of the containment box to hang the integrated automated spraying machine for livestock from an overhead structure.

4. An integrated automated spraying machine for livestock having the following method of use:
the machine is lowered at the appropriate height and the liquid is poured into the tank;
a master switch is set to on in order to set the timer from the control box to regulate the duration of the spray based on recommendation from the manufacturer of the liquid;
a second switch in the control box actuates the motion detector and sets it to automatic.
